(19) United States
(12) Patent Application Publication
(10) Pub. No.: US 2009/0062950 A1
(43) Pub. Date: Mar. 5, 2009

(54) SYSTEM AND METHOD FOR MONITORING PRODUCTION OF CNC MACHINES

(75) Inventor: Frank Chen, Taichung (TW)

Correspondence Address: PAI PATENT & TRADEMARK LAW FIRM, 1001 FOURTH AVENUE, SUITE 3200, SEATTLE, WA, 98154, US

(73) Assignee: REN AN INFORMATION TECHNOLOGY CO., LTD., Taichung (TW)

(21) Appl. No.: 11/845,407

(22) Filed: Aug. 27, 2007

(51) Int. Cl. G06F 19/00

(52) U.S. Cl. 700/95

(57) ABSTRACT

A system and method for monitoring production of CNC machines is provided. The system comprises a monitoring host and a displaying device. The monitoring host comprises an NC interpreter, a production analysis module, and a user interface module. The NC interpreter interprets first format data received from CNC machines into second format data saved within a temporary file. The production analysis module analyzes control codes and parameters of control codes contained in the temporary file to obtain current operation states and information of CNC machines connected to the monitoring host. The user interface module transforms the collected current operation states and information of CNC machines into a user-friendly interface that is displayed on the displaying device, such as a monitor.

### BACKGROUND

1. Field of The Invention

The present invention relates to CNC (Computer Numerical Controlled) machines. More particularly, the present invention relates to a system and a method for monitoring production status and information of CNC machines.

2. Description of Related Art

CNC (Computer Numerical Controlled) machines have been extensively used to machine and fabricate mechanical parts, work pieces, instruments etc. Typically, machining programs should be loaded or edited to the CNC machines prior to machining the work piece. A person who manages a factory generally hopes to obtain production information of the CNC machines located in the factory through a terminal. This production information may include machine operation states, and machine operation data such as current machining programs, operator information, machine utilizations etc.

Especially, when there are various or many CNC machines located in different areas of the factory, the person must personally take a look at each of the CNC machines and record the operation state and information of each machine if the person wants to obtain production information of the machines. Thus, it is really inconvenient and time-consuming.

In addition, the person cannot view the instantaneous production information of all machines at once, resulting in inconvenient and non-optimum machine production scheduling. If some abnormal conditions occur during the operating duration of the machines, the machines may be abnormally stopped or mistakes may occur unless someone who immediately observes and troubleshoots the abnormal conditions. Thus, the production efficiency and output of the machines are influenced and diminished.

Therefore, there is a need to provide a system and method for monitoring production of the machines to mitigate or obviate the aforementioned problems.

### SUMMARY

An object of the present invention provides a method and a system to monitor the production of CNC machines to provide immediate and complete production information to administrators.

Another object of the present invention provides a method and a system to monitor the production of CNC machines so as to monitor remotely and conveniently production information.

A system for monitoring production of CNC machines comprises a monitoring host and a displaying device. The monitoring host comprises an NC interpreter module, a production monitor analysis module and a user interface module.

The NC interpreter module receives a piece of first format data transmitted by the CNC machines and interprets the first format data into a piece of second format data where the second format data are stored in a temporary file.

The production monitor analysis module analyzes pre-defined control codes and control code parameters contained in the temporary file to acquire current production information and status of the CNC machines.

The user interface module transforms the production information and status analyzed and acquired by the production monitor analysis module into a visible information interface. The displaying device shows the visible information interface.

A method for monitoring production of CNC machines comprises the steps of

providing a monitoring host;

utilizing the monitoring host to receive a piece of first format data transmitted by the CNC machines, interpreting the first format data into a piece of second format data, and storing the second format data in a temporary file;

analyzing pre-defined control codes and control code parameters contained in the temporary file to acquire current production information and the status of the CNC machines by a production monitor analysis module;

transforming the production information and status analyzed and acquired by the production monitor analysis module into a visible information interface by a user interface module; and

showing the visible information interface on a displaying device.

Consequently, the system and the method provide the administrator with a way to monitor the real-time machine production status and information at a remote environment such as in the office to know the whole production status and information of the factories. The collected data can also be stored in a database for statistical analysis or record tracking for information when judging an employee's performance.

Further, the present invention transforms the current production status and information into a visible information interface that is shown on the displaying device. The administrator will easily and conveniently see the information.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram of an embodiment to monitor production of CNC machines in accordance with the present invention;

FIG. 2 is a block diagram of the embodiment in FIG. 1;

FIG. 3 is a flow chart of a production monitoring analysis module in FIG. 2;

FIG. 4 is a schematic diagram of an embodiment of an information interface;

FIG. 5 is a flow chart of a remote control analysis module in FIG. 2;

FIGS. 6a and 6b illustrate schematic diagrams of inputting control identifiers of the remote control analysis module; and

FIG. 7 is a flow chart of a file analysis module in FIG. 2.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

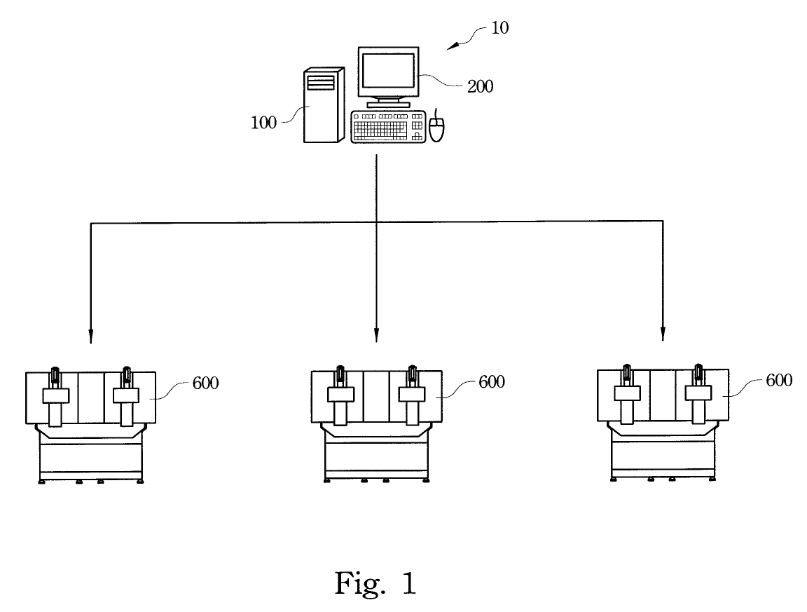

Refer to FIG. 1. An embodiment of a production monitoring system 10 in accordance with the present invention is connected to one or more than one CNC machine 600 to monitor the production of the machines 600. The production monitoring system 10 comprises a monitoring host 100 and a displaying device 200.

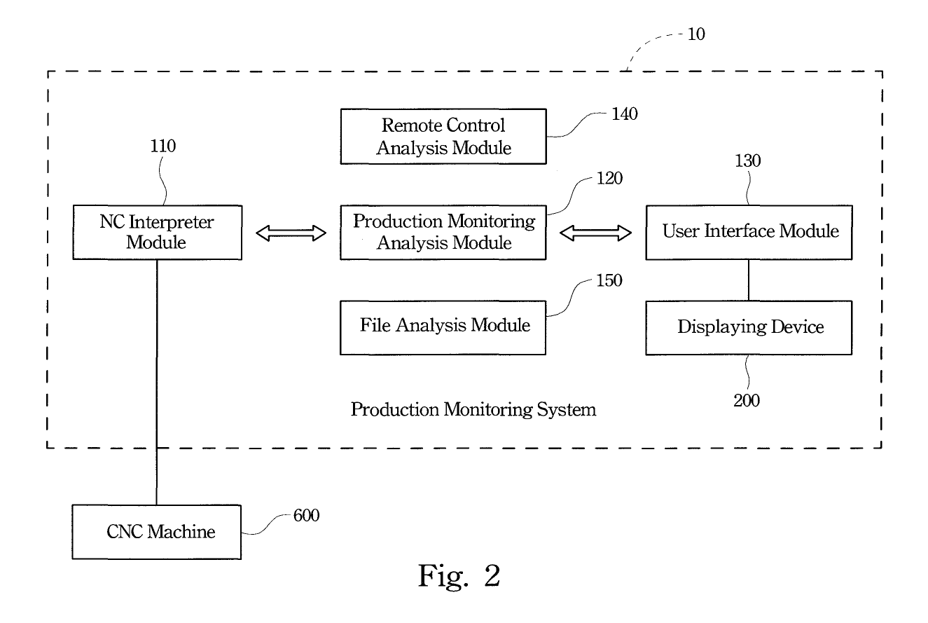

Refer to FIG. 2. The monitoring host 100 comprises an NC interpreter module 110, a production monitor analysis module 120 and a user interface module 130. The NC interpreter module 110 receives a piece of first format data transmitted by the CNC machines 600. The first format data may contain machining programs or commands, and data format of the first format data may be ISO format, EIA (Electronic Industries Association) format or ACSII format. The NC interpreter module 110 checks the first format data and interprets the content of the first format data into a piece of second format data. The second format data is stored in a memory such as a buffer in the form of a temporary file.

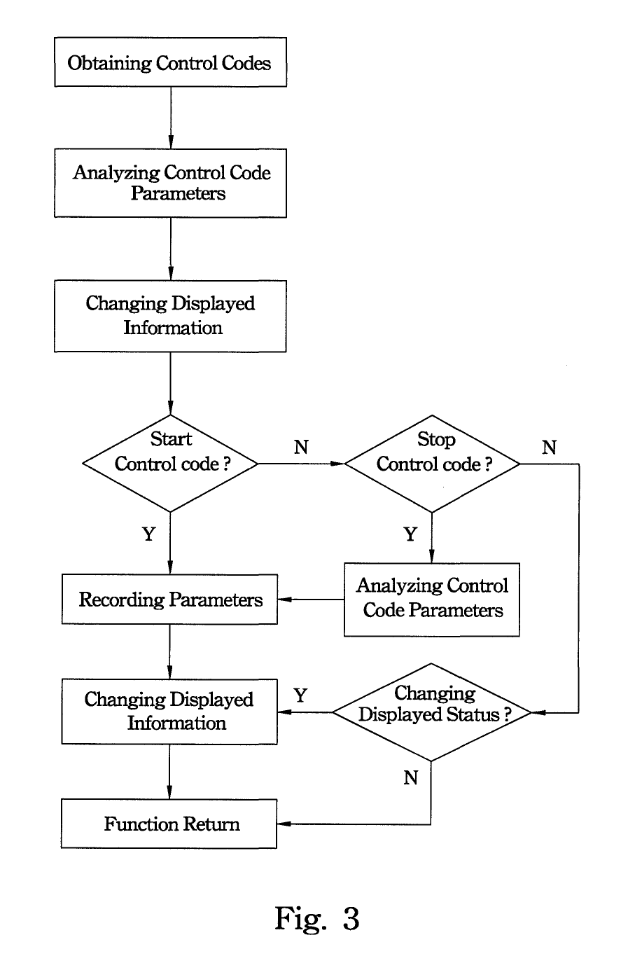

Refer to FIG. 3. The production monitor analysis module 120 analyzes the content of the temporary file to gain current operation state and production information of the machines 600. The operation states of the machines 600 may comprise an “in operation” state, a “changing tool” state, a “machine stop” state, etc. The production information of the machines 600 may comprise “product number”, “product name”, “operator number”, “operation date”, “operation time”, “machine utilization”, etc. Those operation states and production information of the machines 600 are received and collected by analyzing pre-defined control codes and control code parameters contained in the temporary file.

The pre-defined control codes can use numeral strings to indicate respectively the status of specific machines. For example, those numeral strings may be “O8801”, “O6801”, “O8809”, “O6809”, etc., and their indications depend on design selection. In this illustrative embodiment, the string “O8801” is a start control code that represents the machine has been started. Likewise, the string “O8809” is an end control code that represents the machine has been stopped. The numeral strings can be modified to accommodate practical machine conditions. The pre-defined control code parameters can use letter strings, such as “DATE”, “TIME”, etc. to indicate respectively machine production data items. Likewise, the letter strings can be added, deleted and modified to accommodate practical machine conditions. Some illustrative control codes and control code parameters are listed in following Table 1.

TABLE 1

| | | Control code | | |
|---|---|---|---|---|
| Control codes | State | parameters | Description | Examples |
| O6801 | Start | DATE-#3011 | DATE: date | Without using database |
| | | | parameter | O6801 |
| | | | #3011: date | DATE-#3011 |
| | | | variable of | TIME-#3012 |
| | | | machine | MACHINE-M001 |
| | | TIME-#3012 | TIME: time | EMPLOYEE-E003 |
| | | | parameter | MAKE-20060207008-1-1 |
| | | | #3011: time | PROC-BT40-01 |
| | | | variable of | WORK-L005-1 |
| | | | machine | TYPE-A001 |
| | | MACHINE | Machine | With using database |
| | | | number | O6801 |
| | | | parameter | DATE-#3011 |
| | | EMPLOYEE | Employee | TIME-#3012 |
| | | | number | MACHINE-A1 |
| | | | parameter | EMPLOYEE-222 |
| | | MAKE | Work order | CASE-000047C00000000 |
| | | | number | 000010010000 |
| | | | parameter | MAKE-20060207008-1-1 |
| | | PROC | Product number | |
| | | | parameter | |
| | | WORK | Work identifier | |
| | | | parameter | |
| | | TYPE | Work type | |
| | | | parameter | |
| | | CASE | Database KEY | |
| | | | value parameter | |

One skilled in the art would recognize that selection of the letters, strings, symbols etc. of the control codes and the control code parameters depends on design requirements. The abovementioned control codes are illustrative and part of the control codes.

The control codes or the control code parameters for monitoring production information are transmitted by the machines and are received by the NC interpreter module 110. The NC interpreter module 110 interprets the received data that is temporally stored in the temporary file. Therefore, the production monitor analysis module 120 would receive the interpreted data by accessing the temporary file for follow-up processing procedures.

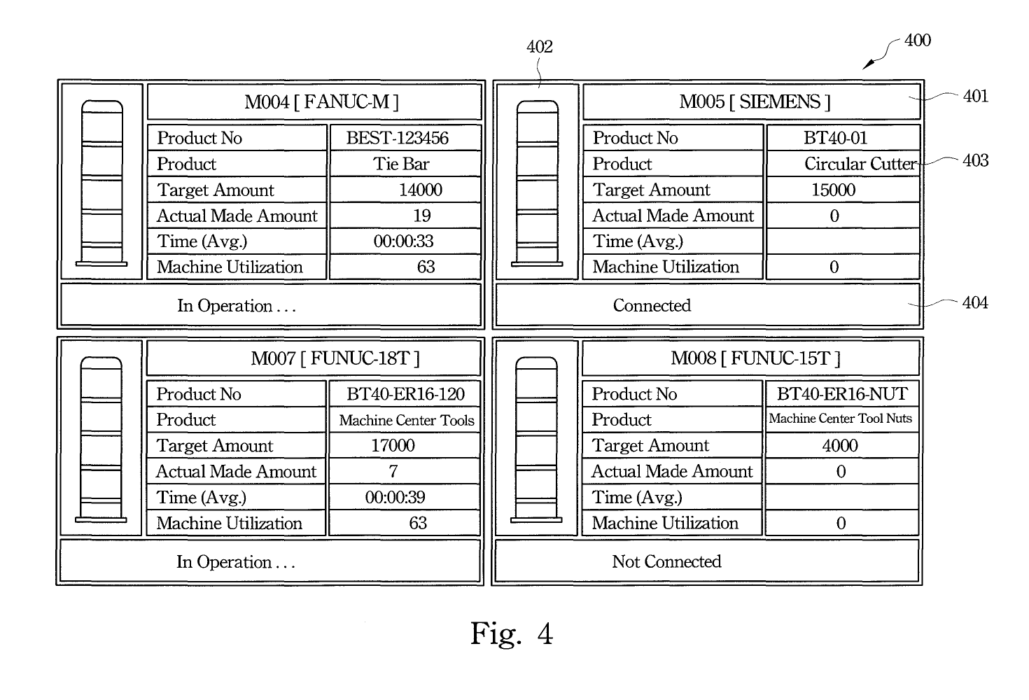

Refer to FIG. 3 and FIG. 4. The user interface module 130 converts the machine status and information to analyze control code parameter data by the production monitor analysis module 120 into a visible information interface 400 and displays the information interface 400 on the displaying device 200. The information interface 400 may be a computer window interface. The displaying device 200 may be a monitor or flat display. Consequently, the displaying device 200 shows the operation status and information of the machines and updates immediately the latest operation status and information of the machines through accessing and analyzing the control codes immediately. Thus, the administrator receives the latest and updated production information through the displaying device 200.

For example, the information interface 400 can be split into different areas or boxes 401 with different identifiers such as colors to show current operation status and production information of the machines on the displaying device 200. Each box 401 is split into a signal area 402, an information area 403 and a status area 404. Colors of the signal areas 402 of the boxes 401 sort the operation status of the machines. For example, red indicates the machine has broken down, green indicates the machine is operating and yellow indicates the machine has temporarily stopped (such as for changing cutters or work piece). The information area 403 comprises multiple columns that show production information, such as product number, product name, target amount, actual made amount, average time, machine utilization etc. Further, the columns could also show working program number, employee name, operation date, operation time, machine number etc. The status area 403 shows the current connection status of the machine. A person skilled in the art recognizes the selection of the boxes 401 of the information interface 400 and the columns of the areas depends on design requirements.

Consequently, the administrator could immediately monitor the operation status and information of the machines in a remote environment, such as in the office. The collected production information and machine status can be further stored in computer database so that tracing the manufacturing history of a given product or statistically analyzing the stored data will be possible in the future. This analyzed information could be used to assess employee performance.

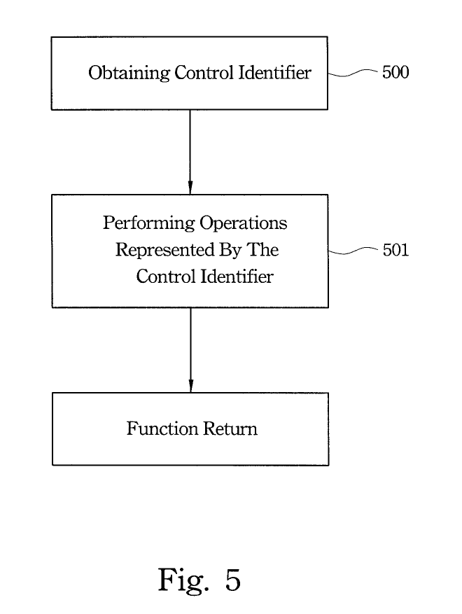

Refer to FIG. 2 and FIG. 5. The embodiment in accordance with the present invention further comprises a remote control analysis module 140 and a file analysis module 150.

The remote control analysis module 140 enables the administrator to transmit and update the machining programs from a remote terminal, i.e. the monitoring host 100 to the connected machines 600. Those operations comprise uploading the machining programs from the machine 600 to the monitoring host 100 and saving the machining programs, and downloading the machining programs from the monitoring host 100 to the machine 600 by requests. For convenient illustration, the term “upload” means transmitting the machining programs from the machines 600 to the monitoring host 100, and the term “download” means transmitting the machining programs from the monitoring host 100 to the machines 600.

An operator inputs control identifiers in the machines 600, the control identifiers are transmitted and received by the monitoring host 100 to obtain the control codes as shown at step 500. The monitoring host 100 performs operations represented by the received control identifiers such as download, upload, inquiries, and update operations of machining programs. The control identifiers may use letters or strings, such as “A”, “C”, “D” etc., to represent a specific operation. In this embodiment, the control identifiers are listed in table II as follows.

TABLE II

| Control | |
|---|---|
| Identifier | Operations represented by the control identifier |
| “A” | merge file |
| “C” | create folder |
| “D” | delete folder |
| “F” | change folder |
| “M900” | non-return feedback file configuration |
| “M901” | forced-return feedback file configuration |
| “N” | obtain designated file |
| “R” | rename file |
| “PMS” | append production monitoring control codes in |
| | transmission configuration |
| “/” | request to return file content of machining programs |
| | contained in a given folder |
| “[ ]” | switch to a given folder in the monitoring host |
| “N99” | request to return the maximum number of machining |
| | programs contained in a given folder |
| “N55” | request to return the machining program information |
| | including program name and annotation in a given folder |
| “N26” | request to return the machining program information |
| | including program name, annotation, date and size in a |
| | given folder |

Likewise, a person skilled in the art recognizes the aforementioned letters, strings, symbols, etc. are illustrative purposes only, and are not limited to the present invention. The aforementioned control identifiers are illustrative and are not limited to the present invention.

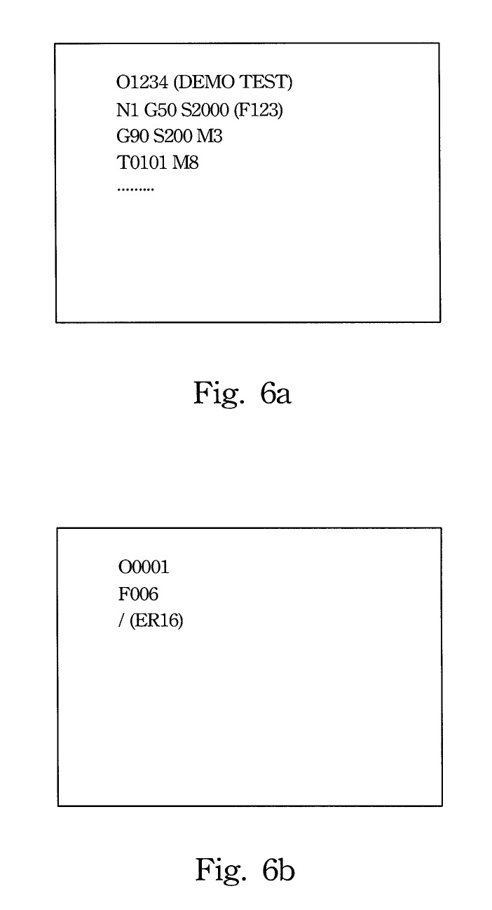

Refer to FIG. 6a and FIG. 6b. The control identifiers are generally inputted in the line next to the program number (O code). For example, in the FIG. 6a, the program number is O1234, and the term “(F123)” in the second line is the control identifier “F” which means uploading the machining program number (O1234) from the machine 600 to the monitoring host 100 and storing the program in the folder F123, where the machine type is FANUC 0 T 0M, for example. In the FIG. 6b, the program number is O0001, this embodiment simultaneously inputs two control identifiers including the term F006 in the second line and the term /(ER16) in the third line. The embodiment combines the control identifier “F” and the control identifier “/”, which means returning the file content of machining program that meets searching criteria ER16 in the folder F006 in the monitoring host 100 to the machine 600.

Further, this module records file operations and writes the records into a feedback file (a log file) during file transmission process. When the operator inputs the control identifier “M900” in the machine 600, the control identifier indicates the operator does not request the monitoring host 100 to return the feedback file to the machine 600. On the other hand, when the operator inputs the control identifier “M901” in the machine 600, the control identifier indicates the operator requests the monitoring host 100 to return the feedback file to the machine 600. In addition, when the control identifier “PMS” is inputted, the control codes or control parameters for the production monitoring analysis module 120 will be appended during the file transmission process.

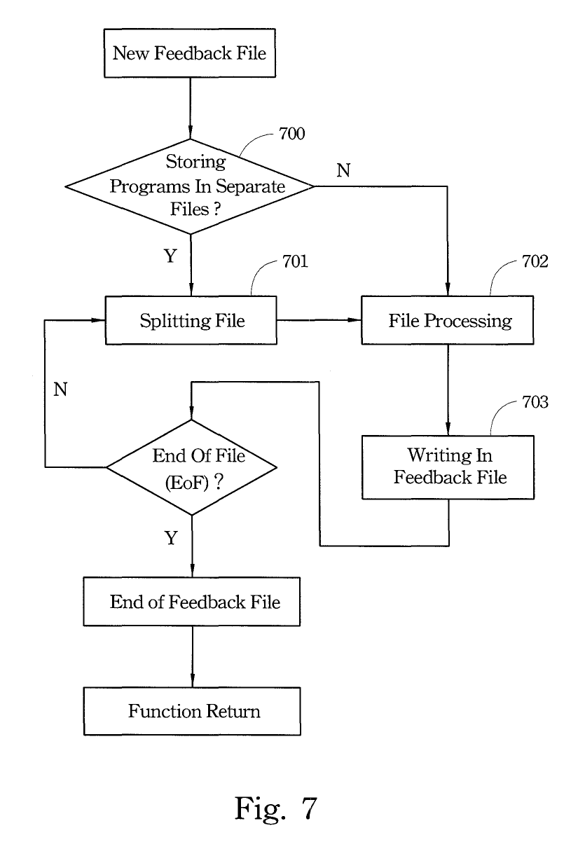

Refer to FIG. 2 and FIG. 7. The file analysis module 150 mainly processes the program files that are uploaded from the machine 600 to the monitoring host 100. When the control code by the remote control analysis module 140 requests the connected machines 600 to upload the machining programs to the monitoring host 100, the file analysis module 150 processes and stores the uploaded program files after the program files are loaded. Since a file may contain several machining programs, the file analysis module 150 determines whether those machining programs are requested to be stored separately, as shown at step 700. If those machining programs are requested to be stored separately, the file analysis module 150 will spit the file into separate files that contain respectively the machine programs and store the separate files, as shown as steps 701 and 702. If it is not, the file analysis module 150 will read pre-configured storage status contained in the temporary file, check path or duplicated file name, renamed file etc. to process the files, and eventually append file annotations as the files are stored. Likewise, the module will record the processing history into the feedback file during the file processing process, as shown at steps 702 and 703. The feedback file can be transmitted to the machine 600 by requests through the control codes as previously described.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for monitoring production of CNC machines, and the system comprising
a monitoring host comprising
an NC interpreter module receiving a piece of first format data transmitted by the CNC machines and interpreting the first format data into a piece of second format data where the second format data are stored in a temporary file;
a production monitor analysis module analyzing pre-defined control codes and control code parameters contained in the temporary file to acquire current production information and status of the CNC machines; and
a user interface module transforming the production information and status analyzed and acquired by the production monitor analysis module into a visible information interface; and
a displaying device showing the visible information interface.

2. The system as claimed in claim 1, wherein the monitoring host further comprises
a remote control analysis module analyzing control identifiers input by the CNC machines to perform a task of machining program management.

3. The system as claimed in claim 2, wherein the monitoring host further comprises
a file analysis module receiving machining programs uploaded by the CNC machines and storing the machining programs in the monitoring host.

4. The system as claimed in claim 1, wherein the pre-defined control codes are numeral strings.

5. The system as claimed in claim 1, wherein the pre-defined control code parameters are letter strings.

6. The system as claimed in claim 2, wherein the pre-defined control identifiers are letters.

7. The system as claimed in claim 2, wherein the pre-defined control identifiers are strings.

8. The system as claimed in claim 1, wherein the visible information interface comprises multiple boxes, each of the boxes are used to show the current production information and status of one of the CNC machines.

9. The system as claimed in claim 8, wherein each of the boxes comprises
a signal area to show the current production status;
an information area to show the current production information; and
a status area to show a connection status of the CNC machine.

10. The system as claimed in claim 8, wherein the visible information interface is a computer window interface, and the displaying device is a monitor.

11. A method for monitoring production of CNC machines, and the method comprising
providing a monitoring host;
utilizing the monitoring host to receive a piece of first format data transmitted by the CNC machines, interpreting the first format data into a piece of second format data, and store the second format data in a temporary file;
analyzing pre-defined control codes and control code parameters contained in the temporary file to acquire current production information and status of the CNC machines by a production monitor analysis module;
transforming the production information and status analyzed and acquired by the production monitor analysis module into a visible information interface by a user interface module; and
showing the visible information interface on a displaying device.

12. The method as claimed in claim 11, further comprising
analyzing control identifiers input by the CNC machines to perform a task of machining program management by a remote control analysis module comprised by the monitoring host.

13. The method as claimed in claim 12, further comprising
receiving machining programs uploaded by the CNC machines and storing the machining programs in the monitoring host by a file analysis module comprised by the monitoring host.

14. The method as claimed in claim 11, wherein the pre-defined control codes are numeral strings.

15. The method as claimed in claim 11, wherein the pre-defined control code parameters are letter strings.

16. The method as claimed in claim 12, wherein the pre-defined control identifiers are letters.

17. The method as claimed in claim 12, wherein the pre-defined control identifiers are strings.

18. The method as claimed in claim 11, wherein the visible information interface comprises multiple boxes, each of the boxes is used to show the current production information and status of one of the CNC machines.

19. The method as claimed in claim 18, wherein each of the boxes comprises
showing the current production status by a signal area in each box;
showing the current production information by an information area in each box; and
showing a connection status of the CNC machine by a status area in each box.

20. The method as claimed in claim 18, wherein the visible information interface is a computer window interface, and the displaying device is a monitor.
